(19) United States
(12) Patent Application Publication
(10) Pub. No.: US 2009/0254585 A1
(43) Pub. Date: Oct. 8, 2009

(54) Method for Associating Administrative Policies with User-Definable Groups of Files

(75) Inventors: David Akers, Merrimack, NH (US); James Beltz, New Boston, NH (US); Frederick S. Glover, Hollis, NH (US); Diane Lebel, Methuen, MA (US); Timothy Mark, Goffstown, NH (US); Brian Tsao, Nashua, NH (US); Angelo Pruscino, Los Altos, CA (US)

Correspondence Address: HICKMAN PALERMO TRUONG & BECKER/ORACLE, 2055 GATEWAY PLACE, SUITE 550, SAN JOSE, CA, 95110-1083, US

(73) Assignee: ORACLE INTERNATIONAL CORPORATION, REDWOOD SHORES, CA (US)

(21) Appl. No.: 12/061,602

(22) Filed: Apr. 2, 2008

(51) Int. Cl. G06F 17/30

(52) U.S. Cl. 707/103 R; 707/E17.045

(57) ABSTRACT

A method and apparatus for associating administrative policies with user-definable groups of files is provided. The groups of files are defined by assigning tags to files or directories. Tags are a part of metadata stored by an operating system for the files and directories. Tags associated with files or directories remain as files or directories are moved or copied in the file system. Files created inside a directory that contains certain tags inherit tags of the parent directory. Command line and graphical interfaces for tag management are provided. The interfaces let users assign tags to files or directories, remove tags assigned to files or directories, or list tags already assigned to files or directories. The interfaces also let users associate services and administrative policies with tags.

### FIELD OF THE INVENTION

The present invention relates to file system supporting tagging of files, tag management, and tag related services.

### BACKGROUND

A file system is a component of an operating system which facilitates storage, organization, and management of directories and files. Current file systems are hierarchical in nature. File systems are tree like structures made up of directories and files. At every directory level, files have unique names. Associated with the file system are a number of services and applications which enable users of the file system to perform permission management, backup, replication, hierarchical storage management, etc. Some users and services work with large sets of files or directories which presents a set of challenges.

One of the challenges faced by users of hierarchical file systems is locating files. The only way a user can navigate to a file is by remembering an explicit directory path and the name of the file, or by using a global search tool to search through the entire file system hierarchy with appropriate wildcards to locate the file. If the search tool finds more than one possible name, the user still needs to know which file to select. For example, in digital photography, hundreds of similarly named files may be created by a single user. In order for the user to retrieve particular photographs such as, for example, a favorite pet, or a wedding, the user will have to navigate to the appropriate point in the directory and then inspect the thumbnails of all of the photographs in order to find the appropriate one.

Some applications use file tagging to address the issues associated with locating files. File tagging works by labeling a group of files with a tag. Various photo management software implements tagging functionality by allowing groups of images to be labeled with tags. For example, files associated with a wedding can be associated with a tag “friends_wedding.” The tag is completely independent from the file position in the directory hierarchical structure. The user may later retrieve the group of files by either remembering the explicit path, or by simply remembering the tag name. Tagging frees the user from remembering the explicit file names and paths and instead allows users to associate a single attribute by which files can be retrieved or searched for.

Current implementations of tagging or storage of additional information associated with files is application-specific. To build on the previous example, if one were to create a presentation using pictures associated with the tag “friends_wedding,” one would want to associate the presentation with the same tag, i.e., “friends_wedding.” The software used to create the presentation will typically allow the addition of an author name, corporation, and perhaps keywords or tags as additional file attributes. However, these additional file attributes can only be viewed with the aid of the application used to design the presentation and not the application used to manage the photos and not the standalone file system. When viewing the file through the file system in the example, the author of the file is not visible; common file attributes such as file owner and creation date are the only attributes made visible by the operating system.

It is possible to augment the file format structure to contain additional attributes such as tags, if a vendor owns both the tools and the file system. However, in UNIX or Linux-type environments, file formats and file metadata conform to a standard specification. Moreover, the tools to modify files are not under control of one software vendor. The standard specification is followed by multiple software vendors whenever designing file modification tools. The file modification tools have a standard set of interfaces that allow the extraction of file metadata attributes. An example of file metadata attributes are the file owner, a group the file belongs to, the time the file was created, the time the file was last modified and other similar attributes.

In UNIX or Linux-type environments, if a file is modified to include an alternate metadata format providing extended file attributes, then some of the existing tools and commands that deal with the original file metadata format may cease to function as designed with the newly modified file metadata format if those existing tools do not support extended attributes for files. For example, if a backup application is used to backup a set of files that were modified to include extended attributes, and if the backup application is not aware of the extended attributes, then whenever the set of files is restored, the attributes will be lost. If interchange protocols such as NFS or SMB/CIFS are used to transfer files between two file systems A and B, respectively, and file systems A and B support different types of metadata, then only compatible attributes might be transferred. For example, file system A might support metadata attributes such as creation time, owner, and modification time, while file system B might support creation time and owner. Under such circumstances, interchange protocols might transfer only the portions of the files that are common to both file systems, so that in a transfer of files between file system A and B, creation time and owner will be transferred, while last modification time will not. It is not standard for an operating system to support extended attributes for files.

In order to be able to add additional attributes to files in an operating system, at least some the tools and operating system services that deal with the files might need to be appropriately modified. In open software environments where multiple vendors may create utilities to modify the same set of files, modifications to file formats are generally not done.

Another challenge faced by users of hierarchical file systems is management of services that deal with large groups of files. Today, if one wants to use a service to replicate, migrate, or backup a file system, one would refer to an entire file system or to a directory or to a specific file. Such approaches are rooted in the file system paths.

An example of a service which deals with large groups of files is hierarchical storage management. Hierarchical storage management relates to movement of data between various physical storage classes, which effects computer system performance. Physical data storage can be classified by a number of performance properties such as volume, speed, cost and access properties.

Traditionally, storage was divided into a three-tier hierarchy consisting of primary, secondary, and tertiary tiers. Memory is considered primary storage. Memory is non-persistent, expensive, and fast. Secondary storage includes disk drives systems, which are much slower than memory, cheaper per unit of storage and persistent. Tertiary storage includes things such as tape, tape is very slow to access, cheap per unit storage and has a large storage capacity. New types of storage devices, which don't fit in the three tier model, are constantly being introduced. For example, SATA hard drives are much cheaper than traditional drive systems, which make SATA drives suitable for bulk data storage. SATA hard drives are also slower than traditional drive systems, yet SATA hard drives are much faster than tape and have random access properties. Therefore, SATA hard drives are used as tertiary storage, and still require the similar type of management as tape storage. A common scenario occurring when tapes are used for storage of files is when a user attempts to access a file that is not in secondary storage, i.e., when the file is only present on tape. In order to retrieve the file, the user must issue an explicit command to a robot that will fetch the tape and transfer the file contents into secondary storage to make the file contents available to the user or a system administrator. With SATA drives, while a user will have access to a file, the performance can be unacceptably slow. Therefore, administrators of systems with a multi-tier storage hierarchy are faced with a task of migrating files between various storage classes according to the needs of the users. In a large enterprise system, there can be thousands of users who create even more files and directories that need to be properly managed.

Based on the foregoing, there are a number of issues faced by users of hierarchical file systems. There is clearly a need for a generic solution which will facilitate management and manipulation of files and directories.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a structure of a table which associates services with tags according to an embodiment of the current invention; and

FIG. 2 is a drawing of a computer system according to an embodiment of the current invention.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

Techniques are provided for associating tasks and administrative policies with user-definable groups of files or directories. In general, tags are keywords or terms associated with pieces of information. In an embodiment of the current invention tags can be associated with directories or files. The groups of files are defined by associating tags with files or directories. A tag defines a group. Multiple tags can be associated with a single file or directory. Therefore, a single file or directory can belong to multiple groups. Tags are a part of metadata stored by an operating system for the files and directories. Tags associated with files or directories remain with those files or directories as those files or directories are moved or copied in the file system. Files created inside a directory that contains certain tags may optionally inherit tags of the parent directory. Command line and graphical interfaces for tag management are provided. The interfaces let users assign tags to files or directories, remove tags assigned to files or directories, or list tags already assigned to files or directories. The interfaces also let users associate services and administrative policies with tags.

### Tag Functionality

In a particular embodiment of the current invention, a tag is part of the file metadata that is only accessible to the operating system. Tags can be implemented in the same manner as other file specific attributes such as date and time, owners, or permissions for the file. The file metadata is part of the file that is outside of what a user typically considers file data. The file metadata is carried along with the file as the file is moved or copied within the file system. Because tags would be considered the same as other file attributes, such as the file owner and file creation date, a copy operation would also copy the tag attributes along with the file. Tools that have been updated to recognize extended attributes will preserve those attributes. However, if tools that have not been updated to recognize extended attributes are used, then those tools may drop the extended attributes.

In another embodiment of the invention, tags can also be implemented as a separate file or a “tag” file instead of being embedded inside the metadata of the original file. The “tag” file can have the same name as the original file, with a different extension. Any other naming convention to associate a tag file with its counterpart can also be used. Any tool that is used to modify the tagged file performs a corresponding operation on the “tag” file.

Tags can be associated with both files and directories. Tags support implicit inheritance. Implicit inheritance allows certain files, which are created within a directory that is associated with certain tags, to be associated with the same tags as the directory. Newly created subdirectories and files associated with the newly created subdirectories will be associated with the same tags as the parent directory.

In one embodiment of the invention, files that are moved into a directory that contains tags will retain the tags originally associated with the files. However, the files will not inherit any tags that are associated with the directory. In another embodiment, files that are moved into a directory will inherit all the tags that are associated the directory.

### Binding Tags to Services and Administrative Policies

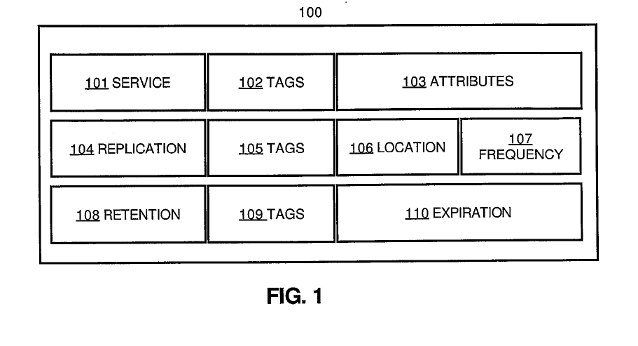

Tags can be bound to system services and applications. Some examples of system services are replication, permissions, and hierarchical storage management migration. In an embodiment of the invention, a user can add a service to a table of existing services that are associated with tags. FIG. 1 depicts a structure of a table 100 which associates services with tags. Every entry in table 100 has the following general structure. An entry in table 100 has a service 101, associated tags 102, and service attributes 103. As an example, a replication service 104 is contained in the repository. Replication service 104 has a set of tags 105 associated with it. The set of tags specify which files are replicated. Replication service 104 also has a set of attributes detailing which location 106 to replicate the files to. Replication is usually performed on critical files. Replication location not only specifies a physical drive, but can also specify a geographical location such as a location outside of the current fire cell, or outside of the current earthquake zone. Another attribute might involve a frequency 107 with which the replication service is performed. Replication can be synchronous, meaning that the file is replicated in all the locations as soon as a write occurs. Alternatively, files may be replicated once every 10 seconds, or once every 30 minutes, or any other time interval. Synchronous replication is used in mission critical transactions, such as an ATM transaction in a bank. In an ATM transaction the prepared transaction is written to persistent storage in multiple locations before the transaction is committed.

A user of the replication service may specify that files with the tag “my_files” are to be replicated. Alternatively, a user may specify that files possessing the “my_files” tag are to be backed up. File tags may exist across multiple directories as well as across multiple file systems such as in an enterprise environment. By specifying a tag value, a file system is able to locate the files that match the specified tag value across all the file systems. A cataloging service can then be used to associate or bind these files with a value-add service. Such an association allows tagged files to be associated with management components without requiring a user to know an explicit file path for individual files.

For example, in a business, there might be a set of files that are critical to the operation of the business. The set of files might need to be replicated. Under such circumstances, the set of files will be identified, tagged, and associated with a replication service. At a later point in time, new files that are critical to the business might be created. These files may also be tagged and added to the replication service. Any updates made to existing tagged and replicated filed will automatically be replicated with no further administrative actions.

Tags can also be used to implement file retention policies through the use of permissions. One example of when files need to be collectively retained is when a lawsuit is filed against a company on a particular topic. The company must then retain every document, both electronic and paper, that is associated with the topic. In an embodiment of the invention, every file related to the topic is then identified and appropriately associated with a “retain” tag. The “retain” tag is then associated with the retention service, which makes the files immutable. Immutable files cannot be changed and cannot be deleted. So, if a user were to issue a command “delete all,” then the “retained” files would still be there. Consequently, once the retention policy no longer needs to be in place, all the files associated with the tag can be dissociated from the retention service. An entry in table 100 will take on the following form: retention 108 service, tags 109 associated with the retention service, and expiration 110 are specified.

Tags can also facilitate hierarchical storage management. A user may specify that files possessing the “my_files” tag are migrated to slow storage. Such service binding may be useful for archiving. A common example is where an email has not been accessed in 6 months. Under such circumstances, it is advantageous to move the email to slower, cheaper storage. However, the email still should be available for online access. The tag mechanism can be used to transparently manage migration of files between various tiers or storage classes.

Furthermore, in one embodiment of the invention, once a tag is bound to a service, if a new file or set of files are created anywhere in the file system, file systems or in the storage hierarchy, and if the file or a set of files are associated with the tag, then the new file or set of files are automatically associated with the service as well. The new file or set of files will be automatically included in any of the operations performed by the service. The files can be tagged manually or implicitly tagged through inheritance. An example of inheritance according to an embodiment of the current invention involves tagging a directory. Subsequently, any files that are created inside the tagged directory will inherit the directory tags.

### Tag Management Interface

In one embodiment of the invention, a user is able to navigate to a certain directory and associate a tag or multiple tags with a given file or a set of files. Any one of the multiple tags can be used to find the file or the set of files without explicitly navigating to a directory or directories where the file or files are located.

In an embodiment of the invention, there are a set of command line interfaces that are consistent with file services provided by most operating systems. The set of command line interfaces also allows users to perform actions such as list tags, set tags, and bind and unbind tags to services. The command line interfaces can have a recursive option that will allow commands to traverse all files within the directory as well as recursively descending into child directories.

Command line interfaces can be used alongside existing file system tools. For example, a “find” command can be used to locate a set of files matching a set of criteria anywhere within the file system. The “find” command can search for files matching any set of criteria, such as wild card matches on the name of the file, files created before a certain date, files created after a certain date, files with a certain owner, etc. Once a file is found matching the set of condition, then the file is appropriately tagged. Correspondingly, existing tools that facilitate searching for files also are extended to allow these tools to search for files that are associated with specified tags.

The capabilities provided by the command line interface can also be accessed through a graphical user interface (GUI). In one embodiment of the invention, every operation that can be performed on a file or a set of files with a command line interface has an associated GUI interface. For example, a user can navigate through the file structure and right click on a file, which will bring up a context menu with choices such as “set tag,” “remove tag,” and “list all tags.”

The user can bind and unbind tags to a particular service as well as configure various service parameters. The user also can issue a command that will list, for a given service, all the tags that are bound to that service.

### Hardware Overview

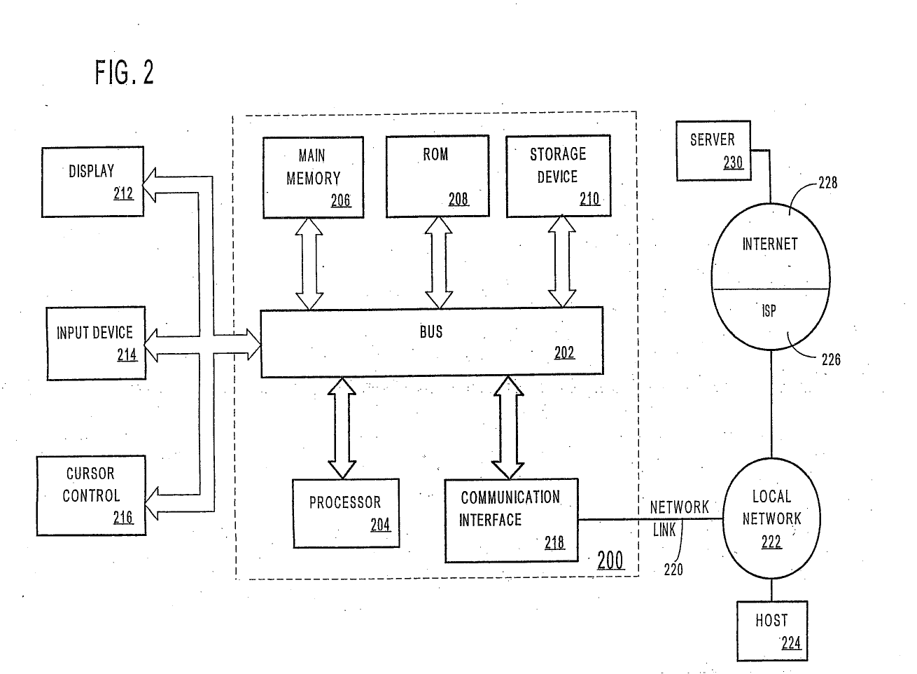

FIG. 2 is a block diagram that illustrates a computer system 200 upon which an embodiment of the invention may be implemented. Computer system 200 includes a bus 202 or other communication mechanism for communicating information, and a processor 204 coupled with bus 202 for processing information. Computer system 200 also includes a main memory 206, such as a random access memory (RAM) or other dynamic storage device, coupled to bus 202 for storing information and instructions to be executed by processor 204. Main memory 206 also may be used for storing temporary variables or other intermediate information during execution of instructions to be executed by processor 204. Computer system 200 further includes a read only memory (ROM) 208 or other static storage device coupled to bus 202 for storing static information and instructions for processor 204. A storage device 210, such as a magnetic disk or optical disk, is provided and coupled to bus 202 for storing information and instructions.

Computer system 200 may be coupled via bus 202 to a display 212, such as a cathode ray tube (CRT), for displaying information to a computer user. An input device 214, including alphanumeric and other keys, is coupled to bus 202 for communicating information and command selections to processor 204. Another type of user input device is cursor control 216, such as a mouse, a trackball, or cursor direction keys for communicating direction information and command selections to processor 204 and for controlling cursor movement on display 212. This input device typically has two degrees of freedom in two axes, a first axis (e.g., x) and a second axis (e.g., y), that allows the device to specify positions in a plane.

The invention is related to the use of computer system 200 for implementing the techniques described herein. According to one embodiment of the invention, those techniques are performed by computer system 200 in response to processor 204 executing one or more sequences of one or more instructions contained in main memory 206. Such instructions may be read into main memory 206 from another machine-readable medium, such as storage device 210. Execution of the sequences of instructions contained in main memory 206 causes processor 204 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 200, various machine-readable media are involved, for example, in providing instructions to processor 204 for execution. Such a medium may take many forms, including but not limited to, non-volatile media, volatile media, and transmission media. Non-volatile media includes, for example, optical or magnetic disks, such as storage device 210. Volatile media includes dynamic memory, such as main memory 206. Transmission media includes coaxial cables, copper wire and fiber optics, including the wires that comprise bus 202. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 204 for execution. For example, the instructions may initially be carried on a magnetic disk of a remote computer. The remote computer can load the instructions into its dynamic memory and send the instructions over a telephone line using a modem. A modem local to computer system 200 can receive the data on the telephone line and use an infra-red transmitter to convert the data to an infra-red signal. An infra-red detector can receive the data carried in the infra-red signal and appropriate circuitry can place the data on bus 202. Bus 202 carries the data to main memory 206, from which processor 204 retrieves and executes the instructions. The instructions received by main memory 206 may optionally be stored on storage device 210 either before or after execution by processor 204.

Computer system 200 also includes a communication interface 218 coupled to bus 202. Communication interface 218 provides a two-way data communication coupling to a network link 220 that is connected to a local network 222. For example, communication interface 218 may be an integrated services digital network (ISDN) card or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic or optical signals that carry digital data streams representing various types of information.

Network link 220 typically provides data communication through one or more networks to other data devices. For example, network link 220 may provide a connection through local network 222 to a host computer 224 or to data equipment operated by an Internet Service Provider (ISP) 226. ISP 226 in turn provides data communication services through the world wide packet data communication network now commonly referred to as the “Internet” 228. Local network 222 and Internet 228 both use electrical, electromagnetic or optical signals that carry digital data streams. The signals through the various networks and the signals on network link 220 and through communication interface 218, which carry the digital data to and from computer system 200, are exemplary forms of carrier waves transporting the information.

Computer system 200 can send messages and receive data, including program code, through the network(s), network link 220 and communication interface 218. In the Internet example, a server 230 might transmit a requested code for an application program through Internet 228, ISP 226, local network 222 and communication interface 218.

The received code may be executed by processor 204 as it is received, and/or stored in storage device 210, or other non-volatile storage for later execution. In this manner, computer system 200 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising performing a machine-executed operation involving instructions, wherein said instructions are instructions which, when executed by one or more processors, cause the one or more processors to perform certain steps including:
associating a tag with a directory;
after associating the tag with the directory, creating a new object within the directory associated with the tag; and
in response to creating the new object within the directory that is associated with the tag, associating the new object with the tag;
wherein only objects newly created in the directory after the tag has been associated with the directory inherit the tag;
wherein objects that already exist in the directory at a time that the tag is associated with the directory do not automatically become associated with the tag.

2. A method comprising performing a machine-executed operation involving instructions, wherein said instructions are instructions which, when executed by one or more processors, cause the one or more processors to perform certain steps including:
associating a tag with a set of file system objects;
associating the tag with a service and a set of attributes associated with the service; and
performing the service on the set of file system objects associated with the tag.

3. The method of claim 2 where the set of file system objects includes a file.

4. The method of claim 2 where the set of file system objects includes a directory.

5. The method of claim 2 where the set of file system objects are located in multiple file systems.

6. The method of claim 2 wherein the service is a replication service.

7. The method of claim 2 wherein the service is a hierarchical storage management service.

8. The method of claim 2 wherein the service is a retention service.

9. The method of claim 2, wherein the service is a backup service.

10. A computer-readable storage medium carrying one or more sequences of instructions which, when executed by one or more processors, causes the one or more processors to perform the method recited in claim 1.

11. A computer-readable storage medium carrying one or more sequences of instructions which, when executed by one or more processors, causes the one or more processors to perform the method recited in claim 2.

12. A computer-readable storage medium carrying one or more sequences of instructions which, when executed by one or more processors, causes the one or more processors to perform the method recited in claim 3.

13. A computer-readable storage medium carrying one or more sequences of instructions which, when executed by one or more processors, causes the one or more processors to perform the method recited in claim 4.

14. A computer-readable storage medium carrying one or more sequences of instructions which, when executed by one or more processors, causes the one or more processors to perform the method recited in claim 5.

15. A computer-readable storage medium carrying one or more sequences of instructions which, when executed by one or more processors, causes the one or more processors to perform the method recited in claim 6.

16. A computer-readable storage medium carrying one or more sequences of instructions which, when executed by one or more processors, causes the one or more processors to perform the method recited in claim 7.

17. A computer-readable storage medium carrying one or more sequences of instructions which, when executed by one or more processors, causes the one or more processors to perform the method recited in claim 8.

18. A computer-readable storage medium carrying one or more sequences of instructions which, when executed by one or more processors, causes the one or more processors to perform the method recited in claim 9.
